(19) United States
(12) Patent Application Publication
(10) Pub. No.: US 2015/0032416 A1
(43) Pub. Date: Jan. 29, 2015

(54) PREDICTIVE METHOD FOR PERFORMING SERVICES

(71) Applicant: Joseph Miller, Berlin, CT (US)

(72) Inventor: Joseph Miller, Berlin, CT (US)

(21) Appl. No.: 14/339,719

(22) Filed: Jul. 24, 2014

Related U.S. Application Data
(60) Provisional application No. 61/858,759, filed on Jul. 26, 2013.

(51) Int. Cl. G01D 11/00

(52) U.S. Cl. CPC G01D 11/00
USPC 702/189

(57) ABSTRACT

A method for predicting services to be performed may include determining all devices which will require service in a designated period of time; determining the devices nearest to a particular technician; determining the devices that the technician can fix; determining the devices which meet goals of at least one of the customer and the service provider; and generating a list of devices to be fixed. The predictive method described herein may also include gathering information about the failure rate of parts on devices to be serviced and using such information to determine the devices which will require service within the designated period of time.

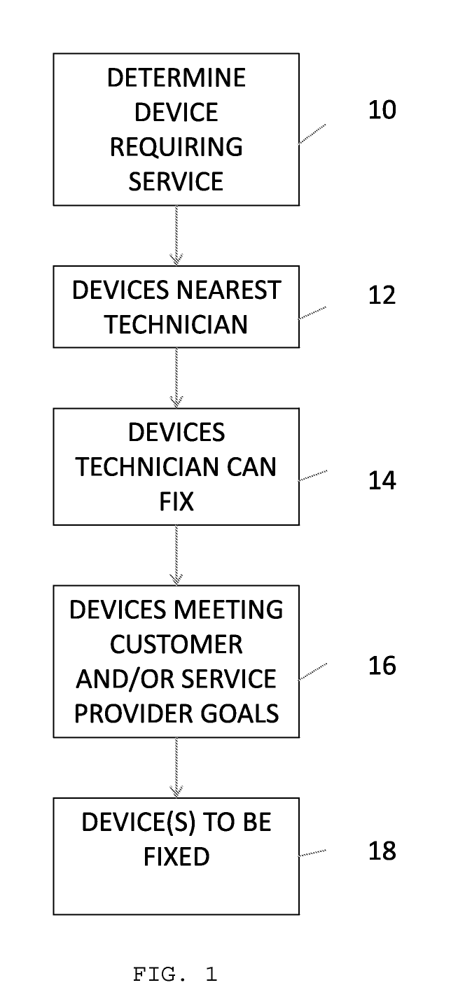

### CROSS REFERENCE TO RELATED APPLICATION

This application claims the benefit of provisional application Ser. No. 61/858,759, filed Jul. 26, 2013.

### BACKGROUND

The present disclosure is directed to a method which allows a service provider to predict when devices, such as printers, will require service and/or maintenance.

Many companies have service contracts with service providers to repair devices such as printers, copiers, multi-function devices etc. Typically, the companies who have the service contracts endure long down times because (1) failure rates of the devices are not monitored, (2) service technicians of the service provider are out of position, (3) the service technicians are not trained to repair the devices requiring servicing; and (4) the service technicians lack the parts necessary to effect the repair.

For the service provider who provides the repair services and/or maintenance of contracted and non-contracted devices, there are a number of deficiencies with the current system. For example, the service provider may not have a proper inventory of repair parts. Further, the service provider may not have proper staffing to effect the repairs in a timely manner which could lead to the service provider having to incur significant overtime payment costs. Still further, the cost of effecting a repair to a device may not be profitable to the service provider.

Thus, there is a need for a method which allows a service provider to predict when devices, either contracted or non-contracted, will require service and/or maintenance and which allows the service provider to better plan for service and/or maintenance.

### SUMMARY

A method for predicting services to be performed broadly comprises determining all devices which will require service in a designated period of time; determining the devices nearest to a particular technician; determining the devices that the technician can fix; determining the devices which meet goals of at least one of the customer and the service provider; and generating a list of devices to be fixed.

The predictive method described herein may also include gathering information about the failure rate of parts on devices to be serviced and using such information to determine the devices which will require service within the designated period of time.

In another embodiment the method described may include determining the devices nearest to a particular technician includes accessing a database of customer location and each device; determining a position of the technician relative to each device to be fixed; determining the traffic conditions between the position of the technician and the device to be fixed.

In another embodiment the method described may include determining a position of the technician includes searching for the device to be fixed in proximity to the technician and reading the position with a global positioning system.

In another embodiment the method described may include determining the amount of time required for the technician to reach the device to be fixed; dispatching the technician to the device to be fixed based on the time required to reach each device to be fixed.

In another embodiment the method described may include determining the devices that the technician can fix includes determining the training level of the technician relative to the device to be fixed.

In another embodiment the method described may include determining the devices that the technician can fix includes determining the spare part available to the technician.

In another embodiment the method described may include determining the devices that the technician can fix includes determining the amount of time remaining in the day and the comparing the amount of time remaining in the day with an estimated time of repair.

In another embodiment the method described may include determining the devices which meet goals of at least one of the customer and the service provider includes determining the urgency of repair calls in a queue of repair calls.

In another embodiment the method described may include determining the devices which meet goals of at least one of the customer and the service provider includes determining at least one of the profitability of the device to be fixed, the competency of the technician, the authorization of overtime, and the existence of a service contract with the customer.

In another embodiment the method described may include transmitting the list of devices to be fixed to the technician and dispatching the technician to the location of the device to be fixed.

In another embodiment the method described may include determining all devices which will require service in a designated period of time includes determining the likelihood of failure of the device based on an overall usage of the device between service calls.

In another embodiment the method described may include determining all devices which will require service in a designated period of time includes determining remaining component life.

In another embodiment the method described may include determining all devices which will require service in a designated period of time includes determining the likelihood of failure of a part based upon at least one of paper usage and a number of copies made.

In another embodiment the method described may include determining all devices which will require service in a designated period of time includes reviewing a historical failure of components.

Other details of the predictive method for performing services are set forth in the following detailed description and the accompanying drawing.

### BRIEF DESCRIPTION OF THE DRAWING

The FIGURE is a flow chart illustrating a predictive method for performing services.

### DETAILED DESCRIPTION

It is highly desirable to be able to estimate the failure of a contracted or a non-contracted device, such as a printer or copier or multi-function devices, slightly before the device fails. By being able to estimate when the device will fail, one is able to timely dispatch a technician who is properly trained, has the right repair parts, and has an appropriate amount of time to fix the device. It also allows the service provider or repair contractor to be able to make business preferences in determining an order of the devices to be repaired and to become aware of the triggers that signify that service/maintenance is needed.

It is also highly desirable for the service provider to be able to consider customer and device factors when prioritizing the device(s) to be fixed, i.e. location, value to the service provider, the time required to fix the asset, etc.

The service provider may be a company who leases the devices and/or has a responsibility for maintaining them or may be an independent company who may or may not have a repair agreement with the device owner to repair the device(s).

In order to perform the predictive method described herein, it is highly desirable that the service provider monitor specific devices and their usage for a period of time to gather device histories. For example, the service provider may monitor remotely a printer or a copier to determine what the paper usage is before particular parts fail. The monitoring step can be performed by a variety of automated technologies including sensors within the devices which transmit information periodically to the service provider via WI-FI transmissions, telephone lines, or other types of transmissions. The information about the devices and the failure rates of certain parts may then be gathered by the service provider and stored in a database in a server or other computer. The information which is gathered and stored may include information about how often a particular make/model requires service; information about how long certain assemblies within a make/model will last (this is referred to as the assembly's yield); and information about certain error codes which when experienced in succession or combination signify service may be needed. Using this information, along with the service history of a specific device, allows a service provider to build a formulaic approach to determining when service will most likely be needed (e.g. percent likelihood of failure based on known failure rates and volume of use).

A method for predicting the need to service devices using such information is shown in the FIGURE. The predictive method for providing service may begin with step 10. In this step, the service provider determines all devices that will require service in the near term. The phrase “near term” may be a matter of a day, a number of days, a week, a month, or some other predetermined period of time. The devices which are identified in this step may include devices at a predetermined percentage, i.e. 90%, likelihood of failure based on overall usage of the device between service calls and/or remaining component life. For example, one may look at the likelihood of failure of a printer part or a copier part, or multi-function device part based upon paper usage or number of copies made. The determination in step 10 may also include a review of the information in the database, such as the historical failure of particular components after so many pages or copies and/or particular errors in combination or succession signifying service may be needed.

In step 12, the service provider may determine the devices which require servicing nearest a particular technician. The determination may be made using GPS (global positioning satellite) data. To perform this step, the service provider database may contain a stored GPS position of each customer location and each device which may need servicing. The service provider can then determines the GPS position of the technician with respect to devices to be fixed. This determination may be based on a GPS reading from a handheld device such as a smart phone or an I-pad device. The technician, when provided with a portable device, such as an I-pad device or a smart phone, can conduct a search for devices requiring servicing in proximity to his/her location. As part of the determination is step 12, the service provider, as well as the technician, can consider the traffic between the technician's current position and a device requiring service. This is an important aspect because it allows determination of how much time would be required to reach the device to be serviced. Therefore, if it is going to take two hours to reach one device requiring servicing and there are two other devices that can be serviced in the same period of time, the service provider, as well as the technician, can determine how best to use the technician's time.

In step 14, the predictive method asks the generic question—is this a device that the technician can fix? In this step, the service provider looks at whether the technician is trained to repair a particular device requiring servicing. The service provider can also look at whether the technician is trained to perform the required repair and whether the technician has the necessary part(s) to effect the repair. If the answer to these inquiries is yes, then this step may also look at whether there is enough time left in the day for the technician to make the repair.

In step 16, the service provider determines the devices that meet the customer's and the service provider's goals. In this step, the service provider can determine if there are existing calls in the queue that are particularly pressing. The service provider may also determine (1) the profitability of the device to be fixed; (2) technician competency; (3) the authorization of overtime; and (4) whether the customer is covered by an existing service contract.

In step 18, the service provider determines the device(s) to be fixed. A list of device(s) to be repaired may be transmitted to the technician via his/her hand held device, smart phone, etc. Once the list is received by the technician, the technician dispatches himself or herself to repair the device(s).

The various steps of the predictive method set out hereinbefore may be performed using a computer which has been programmed to gather the required information from the database and process it as discussed above to arrive at the list of the devices to be repaired.

The benefits of the predictive method for repairing devices described herein are many. It is true that a customer's device rarely goes down without some warning. The method allows down time to be minimized to repair time only. It is an aim of the method to basically eliminate response time from the down time. Another advantage to the method described herein is that the customer does not have to call for service as often. From the service contractor's perspective, the method is advantageous from the standpoint of avoiding emergency calls because now service calls are scheduled in advance. Still further, it is advantageous in that it allows the service contractor to predict the need to purchase parts and staffing levels to effect the needed repairs. For example, one could project part purchases and staffing needs for as long as six to nine months.

What is claimed is:

1. A method for predicting services to be performed comprising:
determining all devices which will require service in a designated period of time;
determining the devices nearest to a particular technician;
determining the devices that the technician can fix;
determining the devices which meet goals of at least one of the customer and the service provider; and
generating a list of devices to be fixed.

2. The method of claim 1, further comprising:
gathering information about the failure rate of parts on said devices to be serviced; and
using said information to determine the devices which will require service within the designated period of time.

3. The method of claim 1, wherein determining the devices nearest to a particular technician includes accessing a database of customer location and each device; determining a position of the technician relative to each device to be fixed; determining the traffic conditions between the position of the technician and the device to be fixed.

4. The method of claim 3 wherein determining a position of the technician includes searching for the device to be fixed in proximity to the technician and reading the position with a global positioning system.

5. The method of claim 3 further comprising:
determining the amount of time required for the technician to reach the device to be fixed; dispatching the technician to the device to be fixed based on the time required to reach each device to be fixed.

6. The method of claim 1, wherein determining the devices that the technician can fix includes determining the training level of the technician relative to the device to be fixed.

7. The method of claim 1, wherein determining the devices that the technician can fix includes determining the spare part available to the technician.

8. The method of claim 1, wherein determining the devices that the technician can fix includes determining the amount of time remaining in the day and the comparing the amount of time remaining in the day with an estimated time of repair.

9. The method of claim 1, wherein determining the devices which meet goals of at least one of the customer and the service provider includes determining the urgency of repair calls in a queue of repair calls.

10. The method of claim 1, wherein determining the devices which meet goals of at least one of the customer and the service provider includes determining at least one of the profitability of the device to be fixed, the competency of the technician, the authorization of overtime, and the existence of a service contract with the customer.

11. The method of claim 1, wherein generating a list of devices to be fixed includes transmitting the list of devices to be fixed to the technician and dispatching the technician to the location of the device to be fixed.

12. The method of claim 1, wherein determining all devices which will require service in a designated period of time includes determining the likelihood of failure of the device based on an overall usage of the device between service calls.

13. The method of claim 1, wherein determining all devices which will require service in a designated period of time includes determining remaining component life.

14. The method of claim 1, wherein determining all devices which will require service in a designated period of time includes determining the likelihood of failure of a part based upon at least one of paper usage and a number of copies made.

15. The method of claim 1, wherein determining all devices which will require service in a designated period of time includes reviewing a historical failure of components.
